(19) United States
(12) Patent Application Publication
(10) Pub. No.: US 2018/0157145 A1
(43) Pub. Date: Jun. 7, 2018

(54) Liquid Crystal Lens, Display Device And Method Of Driving Display Device

(71) Applicant: BOE Technology Group Co., Ltd., Beijing (CN)

(72) Inventors: Qian Wang, Beijing (CN); Xiaochuan Chen, Beijing (CN); Wenqing Zhao, Beijing (CN); Yafeng Yang, Beijing (CN); Xiaochen Niu, Beijing (CN); Jian Gao, Beijing (CN); Pengcheng Liu, Beijing (CN); Wei Wang, Beijing (CN); Jifeng Tan, Beijing (CN)

(21) Appl. No.: 15/552,148

(22) PCT Filed: Jan. 24, 2017
(86) PCT No.: PCT/CN2017/072462

§ 371 Date: Aug. 18, 2017

(30) Foreign Application Priority Data
Jun. 17, 2016 (CN) 201610440137.8

(51) Int. Cl. G02F 1/29

(52) U.S. Cl. CPC G02F 1/29; G02F 2201/122

(57) ABSTRACT

A liquid crystal lens is disclosed in embodiments of the present disclosure. A liquid crystal lens includes: a first substrate and a second substrate disposed opposite to each other; a first electrode layer and a second electrode layer between the first substrate and the second substrate, the second electrode layer including a plurality of second electrodes each of which is capable being applied independently with a voltage and forms a vertical electrical field with the first electrode layer; and blue phase liquid crystals between the first electrode layer and the second electrode layer, wherein, the blue phase liquid crystals in different positions have different degrees of deformation under the action of the vertical electrical field at different intensities, to enable an imaging distance of the liquid crystal lens to vary smoothly along a preset curve. A display device and a method of driving the display device are further disclosed.

### CROSS-REFERENCE TO RELATED APPLICATION

This application is a 371 National Stage application of International Application No. PCT/CN2017/072462, filed on Jan. 24, 2017, which has not yet published, and which claims priority to Chinese Patent Application No. 201610440137.8 filed on Jun. 17, 2016 in the State Intellectual Property Office of China, the disclosures of which are hereby incorporated by reference in their entirety.

### TECHNICAL FIELD

The present disclosure relates to the technical field of display, and particularly, to a liquid crystal lens, a display device and a method of driving a display device.

### BACKGROUND

In conventional curved displaying technology, a display panel is made to have a physically arc-shape or curved-shape so that a curved display panel is achieved. Different positions of the curved display panel face rightly human's eyes, and direct lights emitted from the different positions of the curved display panel converge to straight ahead of the human's eyes, in order to get best visual experience. However, this curve design only improves visual experience of a user stayed at a central observation location, but it fails to achieve similar effect at other observation locations. Moreover, the central observation location generally cannot be changed according to requirements. In addition, the display panel is made to have the physically arc-shape or curved-shape, which occupies a great physical space and is subject to certain restrictions in practical applications, and also, the manufacturing cost and the process difficulty are high.

### SUMMARY

According to embodiments of the present disclosure, there is provided a liquid crystal lens comprising:

a first substrate and a second substrate disposed opposite to each other;

a first electrode layer and a second electrode layer between the first substrate and the second substrate, the second electrode layer including a plurality of second electrodes each of which is capable of being applied independently with a voltage and forms a vertical electrical field with the first electrode layer; and

blue phase liquid crystals between the first electrode layer and the second electrode layer, wherein, the blue phase liquid crystals in different positions have different degrees of deformation under the action of the vertical electrical field at different intensities, to enable an imaging distance of the liquid crystal lens to vary smoothly along a preset curve.

In some embodiments, the first electrode layer is at a side of the first substrate facing towards the second substrate, while the second electrode layer is at a side of the second substrate facing towards the first substrate.

In some other embodiments, the first electrode layer is at the side of the second substrate facing towards the first substrate, while the second electrode layer is at the side of the first substrate facing towards the second substrate.

In some embodiments, the second electrodes are strip-shaped electrodes extended in a column direction or in a row direction, and all the second electrodes are arranged parallel to one another.

In some embodiments, the second electrodes are block-shaped electrodes, and all the second electrodes are arranged in matrix.

In some embodiments, the second electrodes have the same shape and the same size.

According to embodiments of the present disclosure, there is provided a display device comprising the liquid crystal lens according to any one of the above embodiments of the present disclosure.

In some embodiments, the display device further comprises a display panel at a light outgoing side of which the liquid crystal lens is and near the light outgoing side of which the second substrate is.

In some embodiments, the display panel is a liquid crystal display panel or an organic electroluminescent display panel.

According to embodiments of the present disclosure, there is provided a method of driving the display device according to any one of the above embodiments of the present disclosure, and the method comprises:

applying no voltage on the first electrode layer and the second electrode layer, to enable the display device to implement a flat displaying; and

applying a reference voltage on the first electrode layer, while applying different voltages on the second electrodes of the second electrode layer so that, the blue phase liquid crystals in different positions have different degrees of deformation under the action of the vertical electrical field at different intensities, to enable an imaging distance of the liquid crystal lens to vary smoothly along a preset curve so that the display device implements a curved displaying.

In some embodiments, in the abovementioned method, the voltages applied on the second electrodes located from a position which is at a center of the liquid crystal lens to positions which are away from the center of the liquid crystal lens are gradually increased or gradually decreased.

### BRIEF DESCRIPTION OF THE DRAWINGS

FIG. 1 is a schematic view showing a structure of a liquid crystal lens according to an embodiment of the disclosure;

FIG. 2 is a schematic view showing an electric-field intensity of the liquid crystal lens according to the embodiment of the disclosure;

FIG. 3 is a schematic view showing a first arrangement of a second electrode according to an embodiment of the disclosure;

FIG. 4 is a schematic view showing a second arrangement of the second electrode according to the embodiment of the disclosure;

FIG. 5 is a schematic view showing a structure of a display device according to an embodiment of the disclosure; and

FIG. 6 is a flow diagram showing a method of driving a display device according to an embodiment of the disclosure.

### DETAILED DESCRIPTION OF THE EMBODIMENTS

Solutions according to these embodiments of the present disclosure will be described hereinafter in detail and completely with reference to the attached drawings. It should be understood that the same or similar reference numerals throughout the description refer to the same or similar elements or elements having the same or similar function. These embodiments of the present disclosure described hereinafter with reference to the attached drawings are exemplary, and are merely used to illustrate the present disclosure, but not to be regarded as limiting the present disclosure.

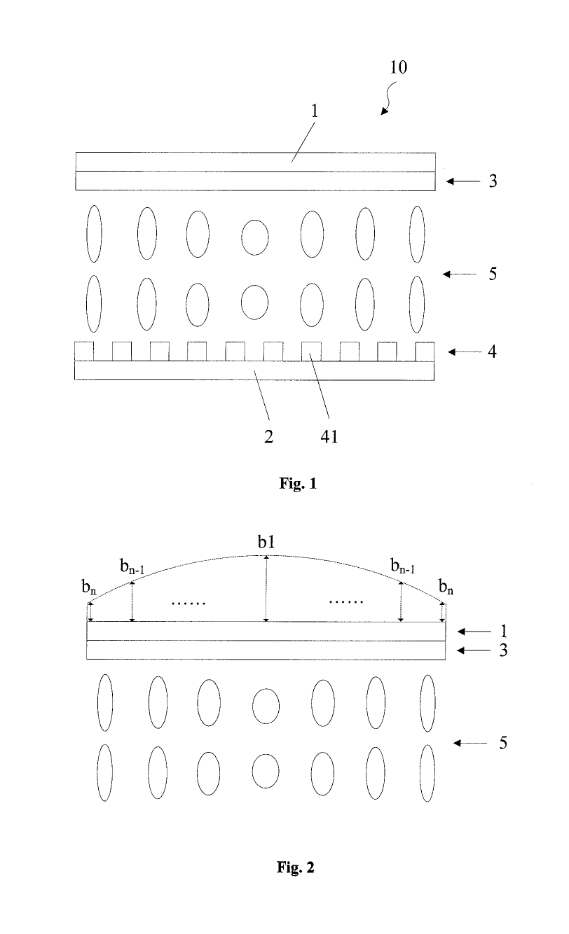

Referring to FIG. 1, according to an embodiment of the disclosure, there provides a liquid crystal lens 10 comprising: a first substrate 1 and a second substrate 2 disposed opposite to each other. A first electrode layer 3 and a second electrode layer 4 are between the first substrate 1 and the second substrate 2, and the second electrode layer 4 includes a plurality of second electrodes 41 each of which is capable of being applied independently with a voltage and forms a vertical electrical field with the first electrode layer 3. Blue phase liquid crystals 5 are between the first electrode layer 3 and the second electrode layer 4. The blue phase liquid crystals 5 in different positions have different degrees of deformation under the action of the vertical electrical field at different intensities, to enable an imaging distance of the liquid crystal lens 10 to vary smoothly along a preset curve.

It should be noted that, the vertical electrical field described in this embodiment indicates an electrical field generated between two substrates parallel to each other and perpendicular to planes where the substrates are. Correspondingly, parallel electrical field is adopted in some display technologies, for example, Advanced Super Dimension Switch (ADS in short) display technology. In this embodiment, in the liquid crystal lens 10, the blue phase liquid crystals 5 can deform under the action of the electrical field between the first electrode layer 3 and the second electrodes 41 on which independently voltages can be applied, and degrees of deformation in different regions can be adjusted by the vertical electrical field. In this way, when the liquid crystal lens 10 according to embodiments of the present disclosure is applied in a display device, an adjustable curved displaying can be achieved without requiring a physical curving, and/or, manufacturing cost and process difficulty of the display device can be reduced.

In order to provide a more clear understanding of the present disclosure, the present disclosure will be further described hereinafter in detail.

Kerr effect is served as working principle of the blue phase liquid crystals 5. A Kerr cell is created by providing the blue phase liquid crystals 5 between the first electrode layer 3 and the second electrode layer 4 parallel to each other. When each second electrode 41 of the second electrode layer 4 is applied with a voltage, an electric field generated between the first electrode layer 3 and the each second electrode 41 acts on the blue phase liquid crystals 5, and the blue phase liquid crystals 5 become optically uniaxial crystals having their optical axis directions parallel to a direction of the electric field. Kerr effect is occurred on the blue phase liquid crystals 5 under the action of the electric field, to generate a double refraction, of which a birefringence Δn is obtained by equation (1) as follows:

Δn=λKE² (1)

in which, λ is a wavelength, K is a Kerr coefficient, and E is an intensity of electric field.

Accordingly, the more the intensity of electric field is, the greater the birefringence Δn of the generated double refraction is.

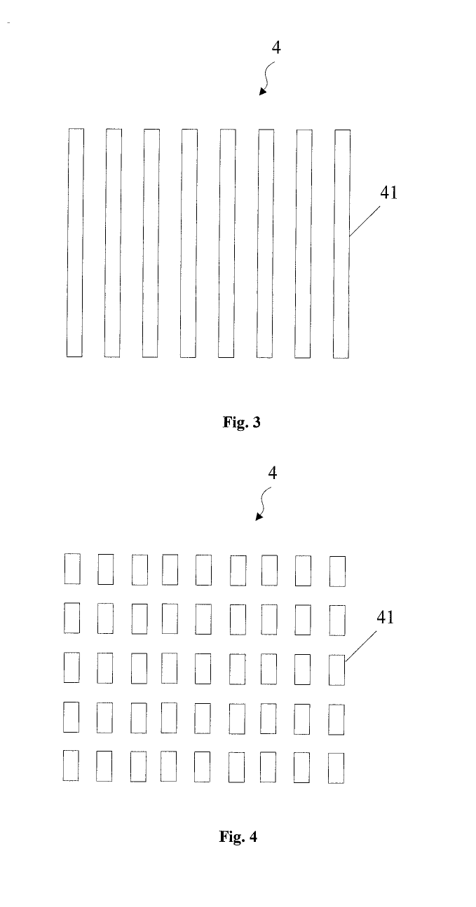

Referring to FIG. 2, which is a schematic view showing an electric-field intensity of the liquid crystal lens 10 during a curved displaying, on the basis of FIG. 1, when the second electrodes 41 are applied independently with different voltages, vertical electric fields are generated between the first electrode layer 3 and the second electrodes 41, so that the blue phase liquid crystals 5 have different degrees of deformation, which causes the blue phase liquid crystals 5 in different positions of the liquid crystal lens 10 to have different birefringence. Since the blue phase liquid crystals 5 in different positions changes with different birefringence, an imaging distance of the liquid crystal lens 10 varies smoothly along a preset curve. Variable intensities of the electrical fields can be seen as b1, . . . , bn-1, bn and the like shown in FIG. 2. Intensities of the electrical fields vary also along a regular curve, for example, are decreased from the center to both sides, shown in FIG. 3. Of course, in other embodiments, voltages applied on different second electrodes 41 may also be adjusted so that intensities of electrical fields are increased from the center to both sides.

Since output spectrums of s light, p light and unpolarized light after passing through the abovementioned Kerr cell are consistent, that is, they are non-related to polarization state of incident light, the liquid crystal lens 10 according to the present embodiment is suitable for incident light of any polarization states.

Provisions of the first electrode layer 3 and the second electrode layer 4 can be flexibly implemented. In an embodiment of the liquid crystal lens 10 shown in FIG. 1, the first electrode layer 3 is at a side of the first substrate 1 facing towards the second substrate 2, while the second electrode layer 4 is at a side of the second substrate 2 facing towards the first substrate 1. However, in other embodiments, it also can be that, the first electrode layer 3 is at the side of the second substrate 2 facing towards the first substrate 1, while the second electrode layer 4 is at the side of the first substrate 1 facing towards the second substrate 2, which is no longer described herein. That is to say, the first electrode layer and the second electrode layer may be flexibly provided on the first substrate and the second substrate, as long as the vertical electrical field generated between the two meets requirements of curved displaying.

The second electrodes 41 of the second electrode layer 4 can be also flexibly designed in pattern, to meets different requirements. For example, in the embodiment shown in FIG. 3, the second electrodes 41 of the second electrode layer 4 may be strip-shaped electrodes extended in a column direction or in a row direction, and all the second electrodes 41 are arranged parallel to one another. For another example, in an embodiment shown in FIG. 4, the second electrodes 41 are block-shaped electrodes, and all the second electrodes are arranged in matrix. In some embodiments, the second electrodes 41 have the same shape and the same size.

In the liquid crystal lens according to the embodiments of the present disclosure, the blue phase liquid crystals 5 of the liquid crystal lens 10 can deform under the action of the electrical field between the first electrode layer 3 and the second electrodes 41 on which independently voltages can be applied, and degrees of deformation in different regions can be adjusted by the vertical electrical field. In this way, when the liquid crystal lens 10 is applied in a display device, an adjustable curved displaying can be achieved without requiring a physical curving, and, manufacturing cost and process difficulty of the display device can be reduced. Moreover, since polarization state of incident light has no influence on blue phase liquid crystals 5, the liquid crystal lens 10 is suitable for incident light of any polarization states.

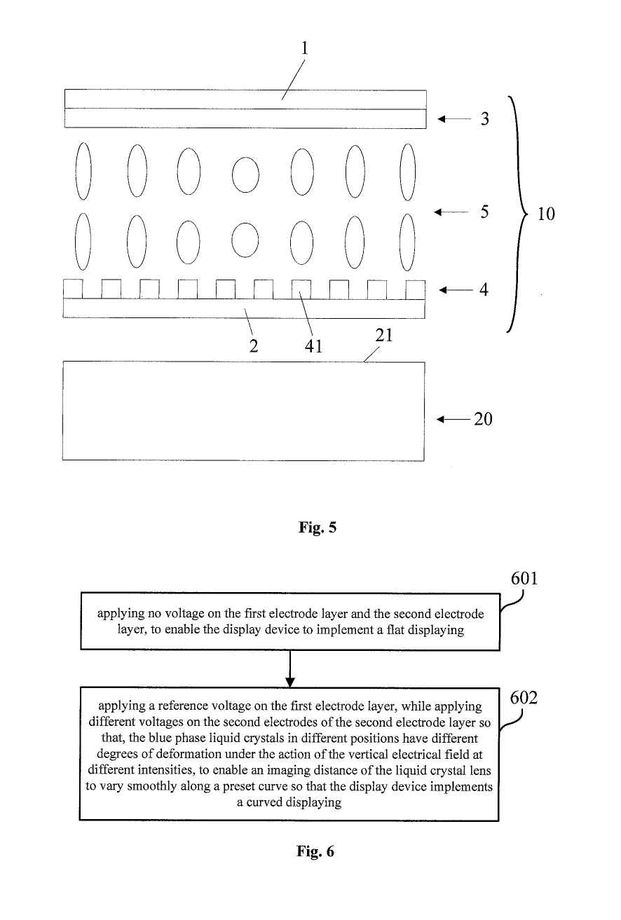

Referring to FIG. 5, according to an embodiment of the present disclosure, there also provides a display device comprising the liquid crystal lens 10 of any one of the above embodiments of the present disclosure. In some embodiments, the display device further comprises a display panel 20 at a light outgoing side 21 of which the liquid crystal lens 10 is and near the light outgoing side 21 of which the second substrate 2 of the liquid crystal lens 10 is.

It should be noted that, the display panel 20 may be a liquid crystal display panel, or else, may be an organic electroluminescent display panel.

In the display device according to the embodiments of the present disclosure, the blue phase liquid crystals 5 of the liquid crystal lens 10 of the display device can deform under the action of the vertical electrical field between the first electrode layer 3 and the second electrodes 41 on which independently voltages can be applied, and degrees of deformation in different regions can be adjusted by the vertical electrical field. In this way, the display device applied with the liquid crystal lens 10 can achieve an adjustable curved displaying without requiring a physical curving, and, manufacturing cost and process difficulty of the display device can be reduced. Moreover, since polarization state of incident light has no influence on blue phase liquid crystals 5, the liquid crystal lens 10 is suitable for incident light of any polarization states.

Referring to FIG. 6, according to an embodiment of the present disclosure, there also provides a method of driving the display device of any one of the above embodiments of the present disclosure. The method comprises:

601, applying no voltage on the first electrode layer and the second electrode layer, to enable the display device to implement a flat displaying; and

602, applying a reference voltage on the first electrode layer, while applying different voltages on the second electrodes of the second electrode layer so that, the blue phase liquid crystals in different positions have different degrees of deformation under the action of the vertical electrical field at different intensities, to enable an imaging distance of the liquid crystal lens to vary smoothly along a preset curve so that the display device implements a curved displaying.

It should be noted that, the reference voltage applied on the first electrode layer is generally a common voltage. However, it is not limited to common voltage, and can be determined upon specific requirements.

In some embodiments, in this method, the voltages applied on the second electrodes located from a position which is at a center of the liquid crystal lens to positions which are away from the center of the liquid crystal lens are gradually increased or gradually decreased.

In the method of driving a display device according to the embodiments of the present disclosure, the blue phase liquid crystals of the liquid crystal lens of the display device can deform under the action of the electrical field between the first electrode layer and the second electrodes on which independently voltages can be applied, and degrees of deformation in different regions can be adjusted by the electrical field. In this way, when the liquid crystal lens is applied in the display device, an adjustable curved displaying can be achieved without requiring a physical curving, switching between a flat displaying and a curved displaying can be achieved, and, manufacturing cost and process difficulty of the display device can be reduced. Moreover, since polarization state of incident light has no influence on blue phase liquid crystals, the liquid crystal lens is suitable for incident light of any polarization states.

It will be apparent for those skilled in the art that some changes and modifications on these embodiments of the present disclosure may be made without departing from the principles and spirit of the present disclosure. All of changes and modifications made within principles and spirit of the present disclosure should be included within the scope of the present disclosure, and the scope of which is defined in the claims and their equivalents.

1. A liquid crystal lens, comprising:
a first substrate and a second substrate disposed opposite to each other;
a first electrode layer and a second electrode layer between the first substrate and the second substrate, the second electrode layer including a plurality of second electrodes each of which is capable of being applied independently with a voltage and forms a vertical electrical field with the first electrode layer; and
blue phase liquid crystals between the first electrode layer and the second electrode layer, wherein, the blue phase liquid crystals in different positions have different degrees of deformation under the action of the vertical electrical field at different intensities, to enable an imaging distance of the liquid crystal lens to vary smoothly along a preset curve.

2. The liquid crystal lens of claim 1, wherein the first electrode layer is at a side of the first substrate facing towards the second substrate, while the second electrode layer is at a side of the second substrate facing towards the first substrate.

3. The liquid crystal lens of claim 1, wherein the second electrodes are strip-shaped electrodes extended in a column direction or in a row direction, and all the second electrodes are arranged parallel to one another.

4. The liquid crystal lens of claim 1, wherein the second electrodes are block-shaped electrodes, and all the second electrodes are arranged in matrix.

5. The liquid crystal lens of claim 3, wherein the second electrodes have the same shape and the same size.

6. A display device comprising the liquid crystal lens of claim 1.

7. The display device of claim 6, further comprising a display panel at a light outgoing side of which the liquid crystal lens is and near the light outgoing side of which the second substrate is.

8. The display device of claim 7, wherein the display panel is a liquid crystal display panel or an organic electroluminescent display panel.

9. A method of driving the display device of claim 6, the method comprising:
applying no voltage on the first electrode layer and the second electrode layer, to enable the display device to implement a flat displaying;
applying a reference voltage on the first electrode layer, while applying different voltages on the second electrodes of the second electrode layer so that, the blue phase liquid crystals in different positions have different degrees of deformation under the action of the vertical electrical field at different intensities, to enable an imaging distance of the liquid crystal lens to vary smoothly along a preset curve so that the display device implements a curved displaying.

10. The method of claim 9, wherein the voltages applied on the second electrodes located from a position which is at a center of the liquid crystal lens to positions which are away from the center of the liquid crystal lens are gradually increased or gradually decreased.

11. The liquid crystal lens of claim 1, wherein the first electrode layer is at the side of the second substrate facing towards the first substrate, while the second electrode layer is at the side of the first substrate facing towards the second substrate.

12. The liquid crystal lens of claim 4, wherein the second electrodes have the same shape and the same size.

13. The display device of claim 6, wherein, in the liquid crystal lens, the first electrode layer is at a side of the first substrate facing towards the second substrate, while the second electrode layer is at a side of the second substrate facing towards the first substrate.

14. The display device of claim 6, wherein, in the liquid crystal lens, the first electrode layer is at the side of the second substrate facing towards the first substrate, while the second electrode layer is at the side of the first substrate facing towards the second substrate.15.

15. The display device of claim 6, wherein, in the liquid crystal lens, the second electrodes are strip-shaped electrodes extended in a column direction or in a row direction, and all the second electrodes are arranged parallel to one another.

16. The display device of claim 6, wherein, in the liquid crystal lens, the second electrodes are block-shaped electrodes, and all the second electrodes are arranged in matrix.

17. The display device of claim 6, wherein, in the liquid crystal lens, the second electrodes have the same shape and the same size.

18. The method of claim 9, wherein the display device further comprises a display panel at a light outgoing side of which the liquid crystal lens is and near the light outgoing side of which the second substrate is.

19. The method of claim 18, wherein the display panel is a liquid crystal display panel or an organic electroluminescent display panel.
